(19) United States
(12) Patent Application Publication
(10) Pub. No.: US 2025/0348588 A1
(43) Pub. Date: Nov. 13, 2025

(54) SERVICE PROCESSING METHOD, APPARATUS, AND DEVICE

(71) Applicant: Alipay (Hangzhou) Information Technology Co., Ltd., Hangzhou (CN)

(72) Inventor: Xinyi FU, Hangzhou (CN)

(21) Appl. No.: 18/869,032

(22) PCT Filed: May 12, 2023
(86) PCT No.: PCT/CN2023/094057

§ 371 Date: Nov. 25, 2024

(30) Foreign Application Priority Data
May 26, 2022 (CN) 202210582406.X

(51) Int. Cl. G06F 21/57

(52) U.S. Cl. CPC G06F 21/57

(57) ABSTRACT

Embodiments of this specification disclose a service processing method, apparatus, and device. The method is applied to a terminal device, the terminal device includes a trusted execution environment, and the method includes: A service processing instruction initiated by a target user for a target service by using a target application is obtained. Service data of the target service are obtained by using a trusted application in the trusted execution environment. Then, the service data are processed in the trusted execution environment based on a prestored service processing policy of the target service, to obtain a corresponding processing result. Service data restored based on the processing result are different from the obtained service data. Finally, the processing result can be provided to the target application. The target application can display a processing result of the target service to the target user based on the processing result.

### TECHNICAL FIELD

This disclosure relates to the field of computer technologies, and in particular, to a service processing method, apparatus, and device.

### BACKGROUND

Data are the most important production materials in many applications such as a risk prevention and control application. As privacy policies of obtaining data by an application in a terminal device become more strict, data collection by the application needs to satisfy principles of “minimum and necessary” and “user authorization”. In the risk prevention and control application, a purpose is to analyze behaviors of a black market, and extract risk characteristics of the black market, so as to perform real-time risk prevention and control. However, a willingness to authorize black market data is very low. Consequently, very great impact is exerted on risk prevention and control. In view of this, it is necessary to provide a technical solution in which service processing (for example, risk prediction) can be more accurately and securely performed based on service data (in particular, including data not authorized by a user).

### SUMMARY

Embodiments of this specification aim to provide a technical solution in which service processing (for example, risk prediction) can be more accurately and securely performed based on service data (in particular, including data not authorized by a user).

To implement the above-mentioned technical solution, the embodiments of this specification are implemented as follows: An embodiment of this specification provides a service processing method, applied to a terminal device. The terminal device includes a trusted execution environment, and the method includes: obtaining a service processing instruction initiated by a target user for a target service by using a target application; obtaining service data of the target service by using a trusted application in the trusted execution environment; processing the service data in the trusted execution environment based on a prestored service processing policy of the target service, to obtain a corresponding processing result, where service data restored based on the processing result are different from the obtained service data; and providing the processing result to the target application, where the processing result is used to trigger the target application to display a processing result of the target service to the target user based on the processing result.

An embodiment of this specification provides a service processing apparatus. The apparatus includes a trusted execution environment, and the apparatus includes: an instruction obtaining module, configured to obtain a service processing instruction initiated by a target user for a target service by using a target application; a service data obtaining module, configured to obtain service data of the target service by using a trusted application in the trusted execution environment; a data processing module, configured to process the service data in the trusted execution environment based on a prestored service processing policy of the target service, to obtain a corresponding processing result, where service data restored based on the processing result is different from the obtained service data; and a result output module, configured to provide the processing result to the target application, where the processing result is used to trigger the target application to display a processing result of the target service to the target user based on the processing result.

An embodiment of this specification provides a service processing device. The service processing device is provided with a trusted execution environment, and includes: a processor, and a storage, configured to store computer-executable instructions. When the computer-executable instructions are executed, the processor is enabled to: obtain a service processing instruction initiated by a target user for a target service by using a target application; obtain service data of the target service by using a trusted application in the trusted execution environment; process the service data in the trusted execution environment based on a prestored service processing policy of the target service, to obtain a corresponding processing result, where service data restored based on the processing result are different from the obtained service data; and provide the processing result to the target application, where the processing result is used to trigger the target application to display a processing result of the target service to the target user based on the processing result.

An embodiment of this specification further provides a storage medium. The storage medium is configured to store computer-executable instructions, and when the executable instructions are executed, the following procedure is implemented: obtaining a service processing instruction initiated by a target user for a target service by using a target application; obtaining service data of the target service by using a trusted application in the trusted execution environment; processing the service data in the trusted execution environment based on a prestored service processing policy of the target service, to obtain a corresponding processing result, where service data restored based on the processing result are different from the obtained service data; and providing the processing result to the target application, where the processing result is used to trigger the target application to display a processing result of the target service to the target user based on the processing result.

### BRIEF DESCRIPTION OF DRAWINGS

To describe the technical solutions in the embodiments of this specification more clearly, the following briefly describes the accompanying drawings needed for describing the embodiments or the existing technology. Clearly, the accompanying drawings in the following descriptions merely show some embodiments of this specification, and a person of ordinary skill in the art can still derive other drawings from these accompanying drawings without creative efforts.

FIG. 1 illustrates an embodiment of a service processing method, according to this specification;

FIG. 2 is a schematic diagram illustrating an execution environment in a terminal device, according to this specification;

FIG. 3 illustrates another embodiment of a service processing method, according to this specification;

FIG. 4 illustrates still another embodiment of a service processing method, according to this specification;

FIG. 5 illustrates an embodiment of a service processing apparatus, according to this specification; and

FIG. 6 illustrates an embodiment of a service processing device, according to this specification.

### DESCRIPTION OF EMBODIMENTS

Embodiments of this specification provide a service processing method, apparatus, and device.

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiments of this specification without creative efforts shall fall within the protection scope of this specification.

### Embodiment 1

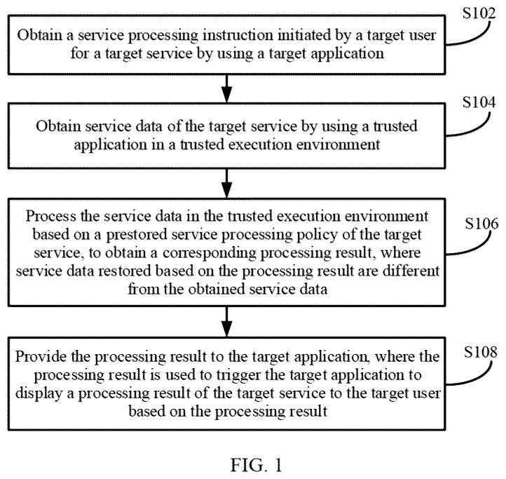

As shown in FIG. 1, this embodiment of this specification provides a service processing method. The method can be performed by a terminal device. The terminal device can be a computer device such as a notebook computer or a desktop computer, or can be an IoT device. The terminal device can be provided with a trusted execution environment. The trusted execution environment can be abbreviated as TEE. The trusted execution environment can be implemented by using a program written in a predetermined programming language (that is, can be implemented in a form of software), or can be jointly implemented by using a hardware device and a pre-written program (that is, can be implemented in a form of hardware and software), etc. The trusted execution environment can be a secure running environment for performing data processing. The method can specifically include the following steps S102 to S108.

Step S102: Obtain a service processing instruction initiated by a target user for a target service by using a target application.

The target service can be any service, for example, an information recommendation service, or a risk prevention and control service or a product transaction service in a financial system. The target user can be any user, for example, can be a user of the terminal device, or can be any user who needs to execute the target service. Specifically, the target user can be set based on an actual situation. This is not limited in this embodiment of this specification. The target application can be an application that provides the target service and that is triggered to run, for example, an application that executes some financial services, or can be a specific instant messaging application. Specifically, the target application can be set based on an actual situation.

During implementation, data are the most important production materials in many applications such as a risk prevention and control application. As privacy policies of obtaining data by an application in the terminal device become more strict, data collection by the application needs to satisfy principles of “minimum and necessary” and “user authorization”. In the risk prevention and control application, a purpose is to analyze behaviors of a black market, and extract risk characteristics of the black market, so as to perform real-time risk prevention and control. However, a willingness to authorize black market data is very low. Consequently, very great impact is exerted on risk prevention and control. In view of this, it is necessary to provide a technical solution in which service processing (for example, risk prediction) can be more accurately and securely performed based on service data (in particular, including data not authorized by a user). This embodiment of this specification provides an implementable processing manner. The following content can be specifically included: When a specific user (namely, the target user) needs to initiate a specific service (namely, the target service), the target application installed in the terminal device can be started. A triggering mechanism of the target service can be set in the target application. The triggering mechanism can be presented in a plurality of different manners such as a hyperlink or a key. The triggering mechanism can be specifically set based on an actual situation. The target user can trigger the triggering mechanism. In this case, the terminal device can generate the service processing instruction by using the target application, so that the terminal device can obtain the service processing instruction initiated by the target user for the target service by using the target application.

Step S104: Obtain service data of the target service by using a trusted application in the trusted execution environment.

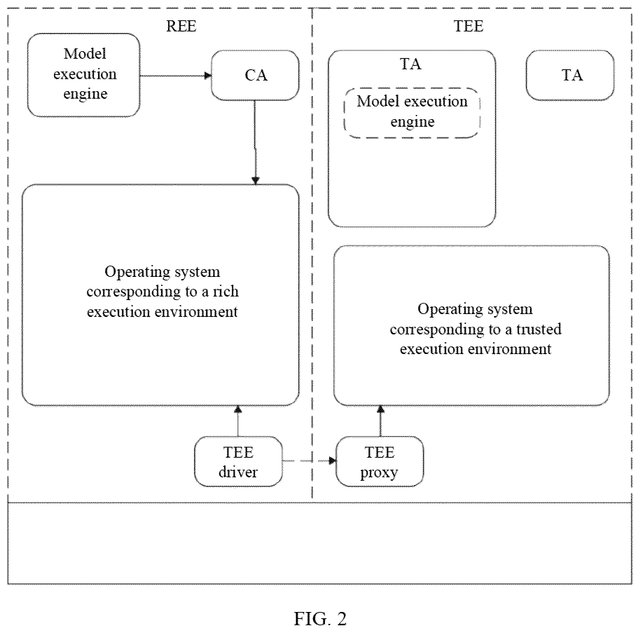

The trusted application can be a preset application that has permission to transfer data to the trusted execution environment. The trusted application can be an application that needs to be installed in the terminal device, or can be a code program that is pre-installed in a specific hardware device of the terminal device, or can be a program that runs in the background and that is set in an operating system of the terminal device in a form of a plug-in, etc. The trusted application can be an application that can be invoked only by a part or a component (for example, a component or a central processing unit corresponding to the trusted execution environment) that has specified permission. The trusted application can be specifically set based on an actual situation. The service data can be data related to the target service. The service data can include data generated in a process in which the user triggers the target service and the target service is executed, and can further include related data provided in a process in which the user triggers the target service and the target service is executed. The trusted execution environment can be a secure data processing environment isolated from another environment. To be specific, processing performed in the trusted execution environment, data generated in a data processing process, etc. cannot be accessed by another execution environment different from the executable environment or an application outside the executable environment. As shown in FIG. 2, the trusted execution environment can be implemented by creating a small operating system that can run independently in a trusted zone (for example, TrustZone), and the trusted execution environment can directly provide a service through a system call (for example, directly processed by a TrustZone kernel). The device can include a rich execution environment (REE) and a trusted execution environment. An operating system such as an Android operating system, an iOS operating system, a Windows operating system, or a Linux operating system installed in a terminal device can run in the REE. Features of the REE can include a powerful function, openness, good extensibility, etc. All functions such as a camera function and a touch function of the device can be provided for an upper-layer application. However, the REE has many potential security risks. For example, the operating system can obtain all data of a specific application. However, it is difficult to verify whether the operating system or the application is tampered with. If the operating system or the application is tampered with, information of the user has a potential security risk. In view of this, the trusted execution environment in the device needs to perform processing. The trusted execution environment has execution space of the trusted execution environment. In other words, an operating system also exists in the trusted execution environment. The trusted execution environment has a higher security level than the REE. Software and hardware resources in the device that can be accessed by the trusted execution environment are separated from those of the REE. However, the trusted execution environment can directly obtain information about the REE, and the REE cannot obtain information about the trusted execution environment. The trusted execution environment can perform processing such as verification through a provided interface, to ensure that user information (for example, payment information and user privacy information) is not tampered with, a password is not hijacked, and information such as a fingerprint or a face is not stolen.

During implementation, in consideration that the trusted execution environment is usually set in the terminal device, and the trusted execution environment is used as a security isolation environment in the terminal device, and can be isolated from another environment in the terminal device, security of data in the trusted execution environment is ensured. Based on this, the service data of the target service can be obtained by using the trusted execution environment. Specifically, to ensure authenticity and accuracy of the service data, the component corresponding to the trusted execution environment can trigger running of the trusted application. After verification performed by the trusted application on the component succeeds, the terminal device can invoke the trusted application, and obtain, by using the trusted application, related data when the user requests the target service or triggers the target service and related data generated when the target service is generated; can use the above-mentioned data as the service data of the target service; and can transfer the obtained service data to the trusted execution environment. The service data are transferred by the trusted application, but the user cannot obtain the service data by using another part or component or by using the target application, and cannot extract plaintext service data from the trusted application. Therefore, the service data can be prevented from being tampered with in a transfer process. In addition, to further ensure data transmission security, the service data can further be encrypted, etc. There can be a plurality of encryption manners such as a symmetric encryption manner or an asymmetric encryption manner. Specifically, the encryption manner can be set based on an actual situation. This is not limited in this embodiment of this specification.

Step S106: Process the service data in the trusted execution environment based on a prestored service processing policy of the target service, to obtain a corresponding processing result, where service data restored based on the processing result are different from the obtained service data.

There can be a plurality of service processing policies, and the service processing policies can be presented in a plurality of different manners. For example, the service processing policy can be established based on content recorded in text data, can be presented by using a pre-trained model. Specifically, the service processing policy can be set based on an actual situation. In addition, different service processing policies can be established based on different target services. For example, if the target service is an information recommendation service, the service processing policy can be a policy used to perform information recommendation. If the target service is a risk prevention and control service in the financial system, the service processing policy can be a policy used to perform risk prevention and control on the financial system. If the target service is a product transaction service, the service processing policy can be a policy used to predict sales of a specific product. There can be a plurality of service processing policies. Different service processing policies can be established in different manners. For example, a service processing policy used to perform information recommendation can be established based on a classification algorithm, or a service processing policy used to perform risk prevention and control on the financial system can be established based on a convolution neural network algorithm.

During implementation, after the service data are transferred to the trusted execution environment, the service data can continue to be processed in the trusted execution environment. To be specific, in the trusted execution environment, the service processing policy of the prestored target service is obtained, and the service processing policy is used to process the service data, to obtain the corresponding processing result. For example, in the trusted execution environment, a risk detection policy in the service processing policy is used to detect whether the service data has a specified risk. If the service data has the specified risk, a processing result that there is a risk in executing the target service can be obtained. Original service data cannot be restored from the processing result. In other words, the service data restored based on the processing result are different from the obtained service data.

Step S108: Provide the processing result to the target application, where the processing result is used to trigger the target application to display a processing result of the target service to the target user based on the processing result.

This embodiment of this specification provides the service processing method, applied to the terminal device. The terminal device includes the trusted execution environment. When the service processing instruction initiated by the target user for the target service by using the target application is obtained, the service data of the target service are obtained by using the trusted application in the trusted execution environment. Then, the service data are processed in the trusted execution environment based on the prestored service processing policy of the target service, to obtain the corresponding processing result. The service data restored based on the processing result are different from the obtained service data. Finally, the processing result can be provided to the target application. The target application can display the processing result of the target service to the target user based on the processing result. In this way, a service model is set in a secure environment including the trusted execution environment, and subsequent data processing is performed in the secure environment, to effectively protect a model structure and a model parameter of a service model of an organization or an institution from being stolen by an attacker. A final output result is not outside the trusted execution environment. In this way, a model extraction attack and a model inversion attack are well prevented, security of service processing and the service model is ensured, and core assets of an enterprise or the organization are protected. In addition, for information that is not authorized by the user, the target application does not collect related data, but performs data processing in the trusted execution environment. The target application obtains only the final output result, to prevent the information that is not authorized by the user from being obtained and used by the target application, and protect information security.

### Embodiment 2

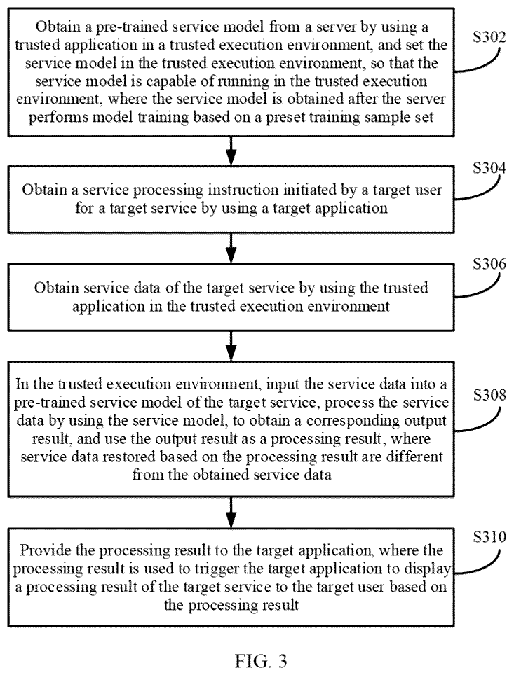

As shown in FIG. 3, this embodiment of this specification provides a service processing method. The method can be performed by a terminal device. The terminal device can be a computer device such as a notebook computer or a desktop computer. A server can be a server of a specific service (for example, a transaction service or a financial service). For example, the server can be a server of a payment service, or can be a server of a related service such as a financial service or an instant messaging service. The terminal device can be provided with a trusted execution environment. The trusted execution environment can be a TEE. The trusted execution environment can be implemented by using a program written in a predetermined programming language (that is, can be implemented in a form of software), or can be jointly implemented by using a hardware device and a pre-written program (that is, can be implemented in a form of hardware and software), etc. The trusted execution environment can be a secure running environment for performing data processing. The method can specifically include the following steps S302 to S310.

Step S302: Obtain a pre-trained service model from the server by using a trusted application in the trusted execution environment, and set the service model in the trusted execution environment, so that the service model is capable of running in the trusted execution environment, where the service model is obtained after the server performs model training based on a preset training sample set.

The service model can be a deep learning model, etc., for example, a neural network model, a decision tree model, or a generative adversarial network. Specifically, the service model can be set based on an actual situation. This is not limited in this embodiment of this specification. The server can be a server used to train the service model and deliver the service model, or can be the background server of a target service, etc. Specifically, the server can be set based on an actual situation. This is not limited in this embodiment of this specification.

During implementation, the server obtains a current public dataset as the training sample set, and can perform, based on a training sample in the training sample set, model training on a service model constructed based on a preset algorithm, to obtain the trained service model, or can obtain a compliant and available dataset as the training sample set through a specified data obtaining channel, and can perform, based on a training sample in the training sample set, model training on a service model constructed based on a preset algorithm, to obtain the trained service model. Usually, a size of the trained service model can be not greater than 2 MB, and a running time can be not greater than 200 milliseconds. In actual applications, the size of the service model and the running time are not conditions that need to be satisfied, but are merely an implementable manner. In actual applications, a service model with another model size and running time can be further set. The service model can be specifically set based on an actual situation. This is not limited in this embodiment of this specification.

The service model can include information such as a model structure and a model parameter. The model parameter can include a weight parameter and/or a bias parameter, etc. This can be specifically set based on an actual situation. A conversion rule or a conversion algorithm corresponding to the service model can be preset based on different service models. There can be a plurality of conversion rules or conversion algorithms. The conversion rule or the conversion algorithm can be specifically set based on an actual situation. This is not limited in this embodiment of this specification. To set a service model of the target service in the trusted execution environment, a conversion rule or a conversion algorithm corresponding to the service model can be obtained, and the service model can be converted based on the obtained conversion rule or the obtained conversion algorithm, so that the service model can be converted into data that are capable of running in the trusted execution environment, and then set in the trusted execution environment.

In actual applications, there can be various specific processing for setting the service model in the trusted execution environment in step S302. An optional processing manner is provided below, and can specifically include processing in step A2 and step A4. Step A2: Convert the service model into data of a preset type that is capable of running in the trusted execution environment.

The preset type can include one or more of a graph file type and a parameter type. In addition, to help the trusted execution environment execute the service model efficiently, a parameter index table can be further set in the trusted execution environment. Processing can be specifically performed in the following manner: If the preset type includes the parameter type, corresponding parameter index information can be generated in the trusted execution environment based on data, of the parameter type, that are obtained through conversion, and then the parameter index information is set in the trusted execution environment.

During implementation, as shown in FIG. 2, the service model can be parsed by using a preset parsing tool, to parse the service model into data of a type such as the graph file type or the parameter type that is capable of directly running in a model execution engine (for example, a lightweight AI execution engine nanoframework), etc. in the trusted execution environment, and the corresponding parameter index table can be created in the trusted execution environment, so that the service model can be set in the trusted execution environment subsequently, and the service model can run in the trusted execution environment.

Step A4: Set data obtained through conversion in the trusted execution environment instead of the service model.

It is worthwhile to note that, to protect security of a data transmission process, a data encryption algorithm can be preset, for example, an AES encryption algorithm or an RSA encryption algorithm. After the data obtained through conversion is obtained, the data obtained through conversion can be encrypted based on the encryption algorithm, to obtain encrypted data. Different types of data included in the data obtained through conversion can be encrypted based on the same encryption algorithm, or can be encrypted based on different encryption algorithms. This can be specifically set based on an actual situation. Then, the encrypted data can be transferred to the trusted execution environment by using the trusted application.

Step S304: Obtain a service processing instruction initiated by a target user for the target service by using a target application.

Step S306: Obtain service data of the target service by using a trusted application in the trusted execution environment.

The service data can include privacy information of the target user and/or device information of the terminal device. The privacy information of the target user can be personal information of the target user, related information of an application installed in a terminal device of the target user, etc. The device information of the terminal device can be related information such as an identifier, a MAC address, and a sequence number of the terminal device. This can be specifically set based on an actual situation.

Step S308: In the trusted execution environment, input the service data into a pre-trained service model of the target service, process the service data by using the service model, to obtain a corresponding output result, and use the output result as the processing result, where service data restored based on the processing result are different from the obtained service data.

During implementation, as shown in FIG. 2, when a related operation of the service model is performed in the model execution engine (specifically, the AI execution engine nanoframework) in the trusted execution environment, a trusted application (TA) corresponding to a client application (CA) retrieves corresponding data based on the parameter index table, to provide a corresponding operator in the model execution engine with data required when the operator is executed. The model execution engine of the trusted execution environment invokes a corresponding operator library to execute a corresponding operator, and the TA provides corresponding data. After execution is completed, an output result can be stored in the trusted execution environment, and subsequent processing such as inference and prediction can continue to be performed.

Through the above-mentioned processing, the model structure and the model parameter of the service model can be effectively protected from being stolen by the attacker, and a final output result is not outside the trusted execution environment. In this way, a model extraction attack and a model inversion attack are well prevented, security of service processing and the service model is ensured, and core assets of an enterprise or an organization are protected. In addition, for information that is not authorized by the user, the target application does not collect related data, but performs model prediction in the trusted execution environment. The target application obtains only a final output result.

Step S310: Provide the processing result to the target application, where the processing result is used to trigger the target application to display a processing result of the target service to the target user based on the processing result.

This embodiment of this specification provides the service processing method, applied to the terminal device. The terminal device includes the trusted execution environment. When the service processing instruction initiated by the target user for the target service by using the target application is obtained, the service data of the target service are obtained by using the trusted application in the trusted execution environment. Then, the service data are processed in the trusted execution environment based on the prestored service processing policy of the target service, to obtain the corresponding processing result. The service data restored based on the processing result are different from the obtained service data. Finally, the processing result can be provided to the target application. The target application can display the processing result of the target service to the target user based on the processing result. In this way, a service model is set in a secure environment including the trusted execution environment, and subsequent data processing is performed in the secure environment, to effectively protect a model structure and a model parameter of a service model of an organization or an institution from being stolen by an attacker. A final output result is not outside the trusted execution environment. In this way, a model extraction attack and a model inversion attack are well prevented, security of service processing and the service model is ensured, and core assets of an enterprise or the organization are protected. In addition, for information that is not authorized by the user, the target application does not collect related data, but performs data processing in the trusted execution environment. The target application obtains only the final output result, to prevent the information that is not authorized by the user from being obtained and used by the target application, and protect information security.

### Embodiment 3

With reference to a specific application scenario, this embodiment describes in detail a service processing method provided in the embodiments of this disclosure. A corresponding application scenario is an application scenario of risk identification or risk detection.

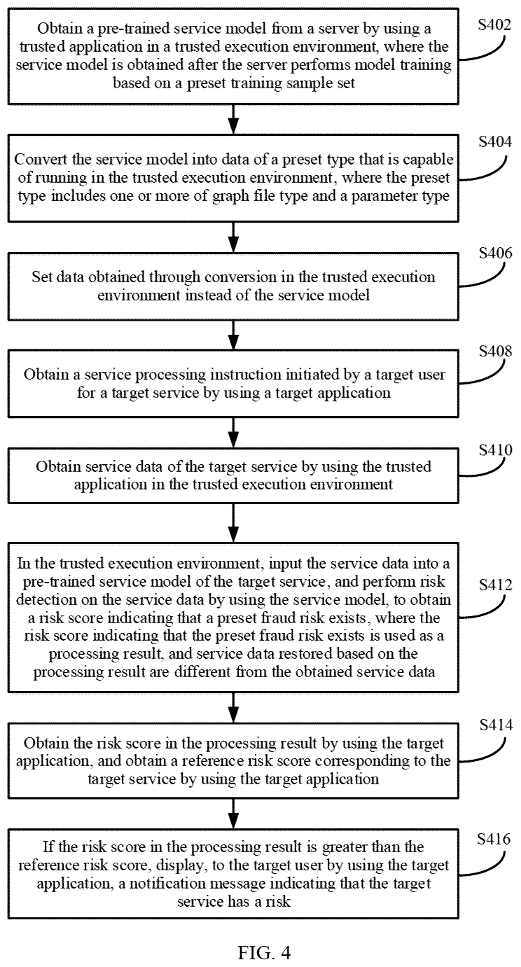

As shown in FIG. 4, the method can be performed by a terminal device. The terminal device can be a mobile terminal device such as a mobile phone or a tablet computer, or can be a device such as a personal computer. The terminal device includes a trusted execution environment. The trusted execution environment can be a TEE. The trusted execution environment can be implemented by using a program written in a predetermined programming language (that is, can be implemented in a form of software), or can be jointly implemented by using a hardware device and a pre-written program (that is, can be implemented in a form of hardware and software), etc. The trusted execution environment can be a secure running environment for performing data processing. The method can specifically include the following steps S402 to S416.

Step S402: Obtain a pre-trained service model from a server by using a trusted application in the trusted execution environment, where the service model is obtained after the server performs model training based on a preset training sample set.

The service model in this embodiment can be a risk detection model used to identify a preset fraud risk. The service model can be constructed based on a neural network algorithm. In actual applications, the service model can alternatively be an open-source MNN model or an ONNX model, or can be an XNN model, etc. This can be specifically set based on an actual situation.

Step S404: Convert the service model into data of a preset type that is capable of running in the trusted execution environment, where the preset type includes one or more of a graph file type and a parameter type.

Step S406: Set data obtained through conversion in the trusted execution environment instead of the service model.

Step S408: Obtain a service processing instruction initiated by a target user for a target service by using a target application.

Step S410: Obtain service data of the target service by using a trusted application in the trusted execution environment.

The service data can include privacy information of the target user and/or device information of the terminal device. For example, the service data (or input data of the service model) can include one or more of the following data: a list of applications installed in the terminal device or a list of applications running in the background of the terminal device.

Step S412: In the trusted execution environment, input the service data into a pre-trained service model of the target service, and perform risk detection on the service data by using the service model, to obtain a risk score indicating that the preset fraud risk exists, where the risk score indicating that the preset fraud risk exists is used as the above-mentioned processing result, and service data restored based on the processing result are different from the obtained service data.

Step S414: Obtain the risk score in the processing result by using the target application, and obtain a reference risk score corresponding to the target service by using the target application.

Step S416: If the risk score in the processing result is greater than the reference risk score, display, to the target user by using the target application, a notification message indicating that the target service has a risk.

This embodiment of this specification provides the service processing method, applied to the terminal device. The terminal device includes the trusted execution environment. When the service processing instruction initiated by the target user for the target service by using the target application is obtained, the service data of the target service are obtained by using the trusted application in the trusted execution environment. Then, the service data are processed in the trusted execution environment based on the prestored service processing policy of the target service, to obtain the corresponding processing result. The service data restored based on the processing result are different from the obtained service data. Finally, the processing result can be provided to the target application. The target application can display the processing result of the target service to the target user based on the processing result. In this way, a service model is set in a secure environment including the trusted execution environment, and subsequent data processing is performed in the secure environment, to effectively protect a model structure and a model parameter of a service model of an organization or an institution from being stolen by an attacker. A final output result is not outside the trusted execution environment. In this way, a model extraction attack and a model inversion attack are well prevented, security of service processing and the service model is ensured, and core assets of an enterprise or the organization are protected. In addition, for information that is not authorized by the user, the target application does not collect related data, but performs data processing in the trusted execution environment. The target application obtains only the final output result, to prevent the information that is not authorized by the user from being obtained and used by the target application, and protect information security.

### Embodiment 4

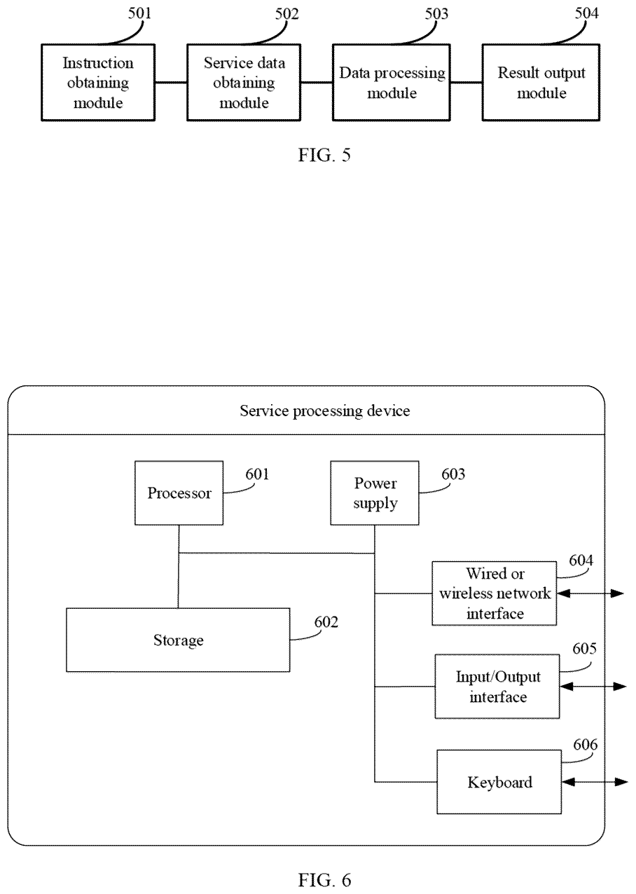

The service processing method provided in the embodiments of this specification is described above. Based on the same idea, this embodiment of this specification further provides a service processing apparatus. The apparatus includes a trusted execution environment, as shown in FIG. 5.

The service processing apparatus includes an instruction obtaining module 501, a service data obtaining module 502, a data processing module 503, and a result output module 504. The instruction obtaining module 501 is configured to obtain a service processing instruction initiated by a target user for a target service by using a target application. The service data obtaining module 502 is configured to obtain service data of the target service by using a trusted application in the trusted execution environment. The data processing module 503 is configured to process the service data in the trusted execution environment based on a prestored service processing policy of the target service, to obtain a corresponding processing result. Service data restored based on the processing result is different from the obtained service data. The result output module 504 is configured to provide the processing result to the target application. The processing result is used to trigger the target application to display a processing result of the target service to the target user based on the processing result.

In this embodiment of this specification, the data processing module 503 is configured to: in the trusted execution environment, input the service data into a pre-trained service model of the target service, process the service data by using the service model, to obtain a corresponding output result, and use the output result as the processing result.

In this embodiment of this specification, the service data include privacy information of the target user and/or device information of the terminal device.

In this embodiment of this specification, the apparatus further includes: a model obtaining module, configured to: obtain the pre-trained service model from a server by using the trusted application in the trusted execution environment, and set the service model in the trusted execution environment, so that the service model is capable of running in the trusted execution environment. The service model is obtained after the server performs model training based on a preset training sample set.

In this embodiment of this specification, the model obtaining module includes: a conversion unit, configured to convert the service model into data of a preset type that is capable of running in the trusted execution environment; and a setting unit, configured to set data obtained through conversion in the trusted execution environment instead of the service model.

In this embodiment of this specification, the preset type includes one or more of a graph file type and a parameter type; and the preset type includes a parameter type. The apparatus further includes: an index generation module, configured to generate corresponding parameter index information based on data, of the parameter type, that are obtained through conversion; and a setting module, configured to set the parameter index information in the trusted execution environment.

In this embodiment of this specification, the service model is a risk detection model used to identify a preset fraud risk, and the service model is a model constructed based on a neural network algorithm.

In this embodiment of this specification, the service data include one or more of the following data: a list of applications installed in the terminal device, a list of applications running in the background of the terminal device, and the output result of the service model is a risk score indicating that the preset fraud risk exists. The apparatus further includes: a score obtaining module, configured to: obtain the risk score in the processing result by using the target application, and obtain a reference risk score corresponding to the target service by using the target application; and a notification display module, configured to: if the risk score in the processing result is greater than the reference risk score, display, to the target user by using the target application, a notification message indicating that the target service has a risk.

This embodiment of this specification provides the service processing apparatus, applied to the terminal device. The terminal device includes the trusted execution environment. When the service processing instruction initiated by the target user for the target service by using the target application is obtained, the service data of the target service are obtained by using the trusted application in the trusted execution environment. Then, the service data are processed in the trusted execution environment based on the prestored service processing policy of the target service, to obtain the corresponding processing result. The service data restored based on the processing result are different from the obtained service data. Finally, the processing result can be provided to the target application. The target application can display the processing result of the target service to the target user based on the processing result. In this way, a service model is set in a secure environment including the trusted execution environment, and subsequent data processing is performed in the secure environment, to effectively protect a model structure and a model parameter of a service model of an organization or an institution from being stolen by an attacker. A final output result is not outside the trusted execution environment. In this way, a model extraction attack and a model inversion attack are well prevented, security of service processing and the service model is ensured, and core assets of an enterprise or the organization are protected. In addition, for information that is not authorized by the user, the target application does not collect related data, but performs data processing in the trusted execution environment. The target application obtains only the final output result, to prevent the information that is not authorized by the user from being obtained and used by the target application, and protect information security.

### Embodiment 5

The service processing apparatus provided in the embodiments of this specification is described above. Based on the same idea, this embodiment of this specification further provides a service processing device, as shown in FIG. 6.

The service processing device can be the terminal device etc. provided in the above-mentioned embodiments, and the service processing device can be provided with a trusted execution environment.

The service processing device can vary greatly based on configuration or performance, and can include one or more processors 601 and a storage 602. The storage 602 can store one or more applications or data. The storage 602 can be a temporary storage or persistent storage. The application stored in the storage 602 can include one or more modules (not shown in the figure), and each module can include a series of computer-executable instructions in the service processing device. Further, the processor 601 can be configured to communicate with the storage 602, to execute a series of computer-executable instructions in the storage 602 on the service processing device. The service processing device can further include one or more power supplies 603, one or more wired or wireless network interfaces 604, one or more input/output interfaces 605, and one or more keyboards 606.

Specifically, in this embodiment, the service processing device includes a storage and one or more programs. The one or more programs are stored in the storage, the one or more programs can include one or more modules, each module can include a series of computer-executable instructions in the service processing device, and one or more processors are configured to execute computer-executable instructions that are included in the one or more programs and that are used to perform the following operations: obtaining a service processing instruction initiated by a target user for a target service by using a target application; obtaining service data of the target service by using a trusted application in the trusted execution environment; processing the service data in the trusted execution environment based on a prestored service processing policy of the target service, to obtain a corresponding processing result, where service data restored based on the processing result are different from the obtained service data; and providing the processing result to the target application, where the processing result is used to trigger the target application to display a processing result of the target service to the target user based on the processing result.

In this embodiment of this specification, the processing the service data in the trusted execution environment based on a prestored service processing policy of the target service, to obtain a corresponding processing result includes: in the trusted execution environment, inputting the service data into a pre-trained service model of the target service, processing the service data by using the service model, to obtain a corresponding output result, and using the output result as the processing result.

In this embodiment of this specification, the service data include privacy information of the target user and/or device information of the terminal device.

In this embodiment of this specification, the following operations are further included: obtaining the pre-trained service model from a server by using the trusted application in the trusted execution environment, and setting the service model in the trusted execution environment, so that the service model is capable of running in the trusted execution environment, where the service model is obtained after the server performs model training based on a preset training sample set.

In this embodiment of this specification, the setting the service model in the trusted execution environment includes: converting the service model into data of a preset type that is capable of running in the trusted execution environment; and setting data obtained through conversion in the trusted execution environment instead of the service model.

In this embodiment of this specification, the preset type includes one or more of a graph file type and a parameter type; and the preset type includes a parameter type. The following operations are further included: generating corresponding parameter index information based on data, of the parameter type, that are obtained through conversion; and setting the parameter index information in the trusted execution environment.

In this embodiment of this specification, the service model is a risk detection model used to identify a preset fraud risk, and the service model is a model constructed based on a neural network algorithm.

In this embodiment of this specification, the service data include one or more of the following data: a list of applications installed in the terminal device, a list of applications running in the background of the terminal device, and the output result of the service model is a risk score indicating that the preset fraud risk exists. The following operations are further included: obtaining the risk score in the processing result by using the target application, and obtaining a reference risk score corresponding to the target service by using the target application; and if the risk score in the processing result is greater than the reference risk score, displaying, to the target user by using the target application, a notification message indicating that the target service has a risk.

This embodiment of this specification provides the service processing device,

including the trusted execution environment. When the service processing instruction initiated by the target user for the target service by using the target application is obtained, the service data of the target service are obtained by using the trusted application in the trusted execution environment. Then, the service data are processed in the trusted execution environment based on the prestored service processing policy of the target service, to obtain the corresponding processing result. The service data restored based on the processing result are different from the obtained service data. Finally, the processing result can be provided to the target application. The target application can display the processing result of the target service to the target user based on the processing result. In this way, a service model is set in a secure environment including the trusted execution environment, and subsequent data processing is performed in the secure environment, to effectively protect a model structure and a model parameter of a service model of an organization or an institution from being stolen by an attacker. A final output result is not outside the trusted execution environment. In this way, a model extraction attack and a model inversion attack are well prevented, security of service processing and the service model is ensured, and core assets of an enterprise or the organization are protected. In addition, for information that is not authorized by the user, the target application does not collect related data, but performs data processing in the trusted execution environment. The target application obtains only the final output result, to prevent the information that is not authorized by the user from being obtained and used by the target application, and protect information security.

### Embodiment 6

Further, based on the above-mentioned methods shown in FIG. 1 and FIG. 4, one or more embodiments of this specification further provide a storage medium, configured to store computer-executable instruction information. In a specific embodiment, the storage medium can be a USB flash drive, an optical disc, a hard disk, etc. When computer-executable instruction information stored in the storage medium is executed by a processor, the following procedure can be implemented: obtaining a service processing instruction initiated by a target user for a target service by using a target application; obtaining service data of the target service by using a trusted application in the trusted execution environment; processing the service data in the trusted execution environment based on a prestored service processing policy of the target service, to obtain a corresponding processing result, where service data restored based on the processing result are different from the obtained service data; and providing the processing result to the target application, where the processing result is used to trigger the target application to display a processing result of the target service to the target user based on the processing result.

In this embodiment of this specification, the processing the service data in the trusted execution environment based on a prestored service processing policy of the target service, to obtain a corresponding processing result includes: in the trusted execution environment, inputting the service data into a pre-trained service model of the target service, processing the service data by using the service model, to obtain a corresponding output result, and using the output result as the processing result.

In this embodiment of this specification, the service data include privacy information of the target user and/or device information of the terminal device.

In this embodiment of this specification, the following operations are further included: obtaining the pre-trained service model from a server by using the trusted application in the trusted execution environment, and setting the service model in the trusted execution environment, so that the service model is capable of running in the trusted execution environment, where the service model is obtained after the server performs model training based on a preset training sample set.

In this embodiment of this specification, the setting the service model in the trusted execution environment includes: converting the service model into data of a preset type that is capable of running in the trusted execution environment; and setting data obtained through conversion in the trusted execution environment instead of the service model.

In this embodiment of this specification, the preset type includes one or more of a graph file type and a parameter type; and the preset type includes a parameter type. The following operations are further included: generating corresponding parameter index information based on data, of the parameter type, that are obtained through conversion; and setting the parameter index information in the trusted execution environment.

In this embodiment of this specification, the service model is a risk detection model used to identify a preset fraud risk, and the service model is a model constructed based on a neural network algorithm.

In this embodiment of this specification, the service data include one or more of the following data: a list of applications installed in the terminal device, a list of applications running in the background of the terminal device, and the output result of the service model is a risk score indicating that the preset fraud risk exists. The method further includes: obtaining the risk score in the processing result by using the target application, and obtaining a reference risk score corresponding to the target service by using the target application; and

if the risk score in the processing result is greater than the reference risk score, displaying, to the target user by using the target application, a notification message indicating that the target service has a risk.

This embodiment of this specification provides the storage medium. When the service processing instruction initiated by the target user for the target service by using the target application is obtained, the service data of the target service are obtained by using the trusted application in the trusted execution environment. Then, the service data are processed in the trusted execution environment based on the prestored service processing policy of the target service, to obtain the corresponding processing result. The service data restored based on the processing result are different from the obtained service data. Finally, the processing result can be provided to the target application. The target application can display the processing result of the target service to the target user based on the processing result. In this way, a service model is set in a secure environment including the trusted execution environment, and subsequent data processing is performed in the secure environment, to effectively protect a model structure and a model parameter of a service model of an organization or an institution from being stolen by an attacker. A final output result is not outside the trusted execution environment. In this way, a model extraction attack and a model inversion attack are well prevented, security of service processing and the service model is ensured, and core assets of an enterprise or the organization are protected. In addition, for information that is not authorized by the user, the target application does not collect related data, but performs data processing in the trusted execution environment. The target application obtains only the final output result, to prevent the information that is not authorized by the user from being obtained and used by the target application, and protect information security.

Specific embodiments of this specification are described above. Other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence to achieve the desired results. In some implementations, multi-tasking and parallel processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer independently performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any proper method. For example, the controller can be a microprocessor or a processor, or a computer-readable medium that stores computer-readable program code (for example, software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The storage controller can also be implemented as a part of control logic of the storage. A person skilled in the art also knows that in addition to implementing the controller by using only the computer-readable program code, logic programming can be performed on method steps to enable the controller to implement the same function in a form of a logic gate, a switch, an application specific integrated circuit, a programmable logic controller, or an embedded microcontroller. Therefore, the controller can be considered as a hardware component, and an apparatus configured to implement various functions in the controller can also be considered as a structure in the hardware component. Alternatively, an apparatus configured to implement various functions can even be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of one or more embodiments of this specification, the functions of each unit can be implemented in one or more pieces of software and/or hardware.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The embodiments of this specification are described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific way, so that the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. Information can be a computer-readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by the computing device. Based on the definition in this specification, the computer-readable medium does not include transitory media such as a modulated data signal and carrier.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions, for example, a program module. Usually, the program module includes a routine, a program, an object, a component, a data structure, etc. for executing a specific task or implementing a specific abstract data type. Alternatively, the one or more embodiments of this specification can be practiced in distributed computing environments. In the distributed computing environments, tasks are executed by remote processing devices connected by using a communication network. In the distributed computing environments, the program module can be located in a local and remote computer storage medium including a storage device.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this application. A person skilled in the art can make various changes and variations to this specification. Any modification, equivalent replacement, or improvement made without departing from the spirit and principle of this specification shall fall within the scope of the claims in this specification.

1. A service processing method, applied to a terminal device, wherein the terminal device comprises a trusted execution environment, and the method comprises:
obtaining a service processing instruction initiated by a target user for a target service by using a target application;
obtaining service data of the target service by using a trusted application in the trusted execution environment;
processing the service data in the trusted execution environment based on a prestored service processing policy of the target service, to obtain a corresponding processing result, wherein service data restored based on the processing result are different from the obtained service data; and
providing the processing result to the target application, wherein the processing result is used to trigger the target application to display a processing result of the target service to the target user based on the processing result.

2. The method according to claim 1, wherein processing the service data in the trusted execution environment based on a prestored service processing policy of the target service, to obtain a corresponding processing result comprises:
in the trusted execution environment, inputting the service data into a pre-trained service model of the target service, processing the service data by using the service model, to obtain a corresponding output result, and using the output result as the processing result.

3. The method according to claim 2, wherein the service data comprise privacy information of the target user and/or device information of the terminal device.

4. The method according to claim 2, wherein the method further comprises:
obtaining the pre-trained service model from a server by using the trusted application in the trusted execution environment, and setting the service model in the trusted execution environment, so that the service model is capable of running in the trusted execution environment, wherein the service model is obtained after the server performs model training based on a preset training sample set.

5. The method according to claim 4, wherein setting the service model in the trusted execution environment comprises:
converting the service model into data of a preset type that is capable of running in the trusted execution environment; and
setting data obtained through conversion in the trusted execution environment instead of the service model.

6. The method according to claim 5, wherein the preset type comprises one or more of a graph file type and a parameter type; and
the preset type comprises a parameter type, and the method further comprises:
generating corresponding parameter index information based on data, of the parameter type, that re obtained through conversion; and
setting the parameter index information in the trusted execution environment.

7. The method according to claim 2, wherein the service model is a risk detection model used to identify a preset fraud risk, and the service model is a model constructed based on a neural network algorithm.

8. The method according to claim 7, wherein the service data comprise one or more of the following data: a list of applications installed in the terminal device, a list of applications running in the background of the terminal device, and the output result of the service model is a risk score indicating that the preset fraud risk exists; and
the method further comprises:
obtaining the risk score in the processing result by using the target application, and obtaining a reference risk score corresponding to the target service by using the target application; and
upon determining that the risk score in the processing result is greater than the reference risk score, displaying, to the target user by using the target application, a notification message indicating that the target service has a risk.

9. (canceled)

10. A computing device comprising a memory and a processor, wherein the memory stores executable instructions that, in response to execution by the processor, cause the computing device to:
obtain a service processing instruction initiated by a target user for a target service by using a target application;
obtain service data of the target service by using a trusted application in a trusted execution environment;
process the service data in the trusted execution environment based on a prestored service processing policy of the target service, to obtain a corresponding processing result, wherein service data restored based on the processing result are different from the obtained service data; and
provide the processing result to the target application, wherein the processing result is used to trigger the target application to display a processing result of the target service to the target user based on the processing result.

11. A non-transitory computer-readable storage medium comprising instructions stored therein that, when executed by a processor of a computing device, cause the computing device to:
obtain a service processing instruction initiated by a target user for a target service by using a target application;
obtain service data of the target service by using a trusted application in a trusted execution environment;
process the service data in the trusted execution environment based on a prestored service processing policy of the target service, to obtain a corresponding processing result, wherein service data restored based on the processing result are different from the obtained service data; and
provide the processing result to the target application, wherein the processing result is used to trigger the target application to display a processing result of the target service to the target user based on the processing result.

12. The computing device according to claim 10, wherein the computing device being caused to process the service data in the trusted execution environment based on a prestored service processing policy of the target service, to obtain a corresponding processing result includes being caused to:
in the trusted execution environment, input the service data into a pre-trained service model of the target service, process the service data by using the service model, to obtain a corresponding output result, and use the output result as the processing result.

13. The computing device according to claim 12, wherein the service data comprise privacy information of the target user and/or device information of the terminal device.

14. The computing device according to claim 12, wherein the computing device is further caused to:
obtain the pre-trained service model from a server by using the trusted application in the trusted execution environment, and set the service model in the trusted execution environment, so that the service model is capable of running in the trusted execution environment, wherein the service model is obtained after the server performs model training based on a preset training sample set.

15. The computing device according to claim 14, wherein the computing device being caused to set the service model in the trusted execution environment includes being caused to:
convert the service model into data of a preset type that is capable of running in the trusted execution environment; and
set data obtained through conversion in the trusted execution environment instead of the service model.

16. The computing device according to claim 15, wherein the preset type comprises one or more of a graph file type and a parameter type; and
the preset type comprises a parameter type, and the computing device is further caused to:
generate corresponding parameter index information based on data, of the parameter type, that re obtained through conversion; and
set the parameter index information in the trusted execution environment.

17. The computing device according to claim 12, wherein the service model is a risk detection model used to identify a preset fraud risk, and the service model is a model constructed based on a neural network algorithm.

18. The computing device according to claim 17, wherein the service data comprise one or more of the following data: a list of applications installed in the terminal device, a list of applications running in the background of the terminal device, and the output result of the service model is a risk score indicating that the preset fraud risk exists; and
the computing device is further caused to:
obtain the risk score in the processing result by using the target application, and obtain a reference risk score corresponding to the target service by using the target application; and
upon determining that the risk score in the processing result is greater than the reference risk score, display, to the target user by using the target application, a notification message indicating that the target service has a risk.

19. The non-transitory computer-readable storage medium according to claim 11, wherein the computing device being caused to process the service data in the trusted execution environment based on a prestored service processing policy of the target service, to obtain a corresponding processing result includes being caused to:
in the trusted execution environment, input the service data into a pre-trained service model of the target service, process the service data by using the service model, to obtain a corresponding output result, and use the output result as the processing result.

20. The non-transitory computer-readable storage medium according to claim 19, wherein the computing device is further caused to:
obtain the pre-trained service model from a server by using the trusted application in the trusted execution environment, and set the service model in the trusted execution environment, so that the service model is capable of running in the trusted execution environment, wherein the service model is obtained after the server performs model training based on a preset training sample set.

21. The non-transitory computer-readable storage medium according to claim 20, wherein the computing device being caused to set the service model in the trusted execution environment includes being caused to:
convert the service model into data of a preset type that is capable of running in the trusted execution environment; and
set data obtained through conversion in the trusted execution environment instead of the service model.
